(19) United States
(12) Patent Application Publication
(10) Pub. No.: US 2013/0039238 A1
(43) Pub. Date: Feb. 14, 2013

(54) Method Of Operating A Wireless Device And Processor For A Wireless Device

(71) Applicants: Luis Miguel Santos Barreto, Camberley (GB); Stuart I. Geary, Fleet (GB); Frederic Garreau, Betton (FR)

(72) Inventors: Luis Miguel Santos Barreto, Camberley (GB); Stuart I. Geary, Fleet (GB); Frederic Garreau, Betton (FR)

(73) Assignee: Renesas Mobile Corporation

(21) Appl. No.: 13/208,913

(22) Filed: Aug. 12, 2011

(51) Int. Cl. H04W 52/02

(52) U.S. Cl. 370/311

(57) ABSTRACT

A wireless device operates such that at least a part of a radio system of the wireless device is temporarily shut down so as to be unable to receive downlink frames and is powered up so as to be capable of receiving downlink frames. The wireless device schedules the transmission time of an uplink frame to occur when the radio system of the wireless device has been powered up so that the wireless device is capable of receiving a downlink frame.

### TECHNICAL FIELD

The present invention relates to a method of operating a wireless device and a processor for a wireless device.

### BACKGROUND

Wireless devices typically transmit and receive data and signals to and from a network in bursts, at times that are according to a predetermined schedule and/or according to need. The term “wireless device” as used herein includes in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USB dongles, etc., as well as fixed or more static devices, such as personal computers, game consoles and other generally static entertainment devices, various other domestic and non-domestic machines and devices, etc. The term “user equipment” is often used to refer to wireless devices in general, and particularly mobile wireless devices.

For example, wireless devices may make use of discontinuous transmission (DTX) and/or discontinuous reception (DRX), particularly to save battery life but also to help reduce network congestion. The wireless device and the network negotiate time periods in which data transfer can occur by the device transmitting or receiving data respectively. During other times, the device turns its radio system off and enters a low power state. Every time the device turns its radio system on again in order to be able to transmit or receive, the device enters a high power state, reducing battery life before recharging is required. The term “radio system” is typically used in this specification to refer to one or more of the radio front end, antenna(s), and relevant processing circuitry and software required for transmission/reception in a wireless device. In at least some circumstances, the term “radio system” is used to refer to all of such components.

### SUMMARY

According to a first aspect of the present invention, there is provided a method of operating a wireless device to schedule wireless transmission of uplink frames by the wireless device, the method comprising: operating the wireless device such that at least a part of a radio system of the wireless device is temporarily shut down so as to be unable to receive downlink frames and is powered up so as to be capable of receiving downlink frames; and the wireless device scheduling the transmission time of an uplink frame to occur when the radio system of the wireless device has been powered up so that the wireless device is capable of receiving a downlink frame.

In this aspect, a wireless device coordinates the transmission of an uplink frame so that it occurs at a time when the wireless device has already been powered up to be able to receive a downlink frame. At that time, the wireless device may actually be receiving a downlink frame or may be merely receptive to or “looking for” incoming downlink frames. As discussed further below, the transmission time for an uplink frame may coincide or be substantially simultaneous with a reception time when the wireless device is receiving or at least powered up to be able to receive a downlink frame, or the transmission time and reception time may overlap somewhat or one be entirely within the other, or the transmission time in certain examples may follow shortly after the reception time. In any event, the coordination of transmission and reception times of this aspect allows the wireless device to be idle for a maximum period of time, with minimum power-ups for transmission and reception, thus improving battery life or other power consumption of a typical wireless device. The term “frame” is in general used in this specification broadly, and may for example include what is sometimes referred to in some applications and protocols as “sub-frames”.

In an embodiment, the wireless device operates using discontinuous reception in which a receiver of the wireless device is periodically switched on and off and the wireless device operates using discontinuous transmission in which a transmitter of the wireless device is periodically switched on and off, the scheduling of the transmission time of the uplink frame being such as to cause the transmitter to be switched on when the receiver has been switched on. As noted above, discontinuous transmission (DTX) and/or discontinuous reception (DRX) are used particularly to save battery life but also to help reduce network congestion.

In an embodiment, the wireless device schedules the transmission time of an uplink frame to substantially align with the time when the wireless device is receiving a downlink frame. The transmission time of an uplink frame may therefore be substantially simultaneous with the reception of a downlink frame. In this respect, it will be appreciated that the total time required to send an uplink frame may be less than the total time required to receive a downlink frame, and vice versa, depending on the nature of and particularly the size of the uplink and downlink frames. The transmission time may therefore be short enough to fall wholly within the reception time, or vice versa, or they may overlap, or they may precisely coincide. All of these are to be understood as falling within the term “substantially align” as used herein for certain examples.

In an embodiment, the wireless device schedules the transmission time of an uplink frame to occur after the wireless device begins receiving a downlink frame. This may be as an alternative to the embodiment described above, or may be used for some uplink frames with the embodiment described above being used for other uplink frames. In an embodiment, the wireless device receives a downlink frame that is a silence insertion descriptor frame and the uplink frame is a silence insertion descriptor frame that is an echo back of the received downlink silence insertion descriptor frame. In a specific example, the transmission time is preferably scheduled to occur shortly after the wireless device begins receiving a downlink frame, i.e. a time that is short compared to the DRX timer that may be used in a specific example such that it can be assured that the radio system of the wireless device is still powered up.

In an embodiment, the uplink frame is a control-plane frame or a silence insertion descriptor frame. As discussed further below, control-plane frames are used for control data, i.e. the signalling protocol's traffic needed to run the system, such as paging, call set-up, etc. Again as discussed further below, silence insertion descriptor frames are used in so-called comfort noise generation.

In an embodiment, the wireless device is transmitting actual audio frames and then ceases sending actual audio frames and generates a first silence insertion descriptor frame, the scheduling of the transmission of the first silence insertion descriptor frame being such that transmission of the first silence insertion descriptor frame is delayed as necessary so as to occur when the radio system of the wireless device is next powered up to be capable of receiving a downlink frame.

In an embodiment, the wireless device is transmitting actual audio frames and then ceases sending actual audio frames and sends a first silence insertion descriptor frame, the first silence insertion descriptor frame being retransmitted when the radio system of the wireless device is next powered up to be capable of receiving a downlink frame.

In an embodiment, the downlink frame is an actual audio frame or a silence insertion descriptor frame.

In an embodiment, the wireless device reschedules the transmission time of the uplink frame if a target transmission time of the uplink frame occurs before the wireless device has been powered up so that the wireless device is capable of receiving a downlink frame, or if a delay tolerance for the uplink frame is exceeded.

According to a second aspect of the present invention, there is provided apparatus comprising: at least one processor; and at least one memory including computer program code; the at least one memory and the computer program code being configured to, with the at least one processor, cause a wireless device that includes the apparatus at least: to operate such that at least a part of a radio system of the wireless device is temporarily shut down so as to be unable to receive downlink frames and is powered up so as to be capable of receiving downlink frames; and to schedule the transmission time of an uplink frame to occur when the radio system of the wireless device has been powered up so that the wireless device is capable of receiving a downlink frame.

There may also be provided a wireless device comprising apparatus as described above.

There may also be provided a computer program comprising code such that when the computer program is executed on a computing device, the computing device is arranged to carry out a method as described above.

There may also be provided a non-transitory computer-readable storage medium comprising a set of computer-readable instructions stored thereon, which, when executed by a processing system, cause the processing system to as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically a timing diagram for uplink and downlink frames in a prior art system;

FIG. 2 shows schematically a timing diagram for transmission and reception of uplink and downlink frames in a first example of an embodiment of the present invention;

FIG. 3 shows schematically a timing diagram for transmission and reception of uplink and downlink frames in a second example of an embodiment of the present invention;

FIG. 4 shows schematically a timing diagram for transmission and reception of uplink and downlink frames in a third example of an embodiment of the present invention; and,

FIG. 5 shows schematically a user equipment or wireless device, in this case in the form of a mobile phone/smartphone in communication with a radio mast.

### DETAILED DESCRIPTION

As noted above, wireless devices may make use of discontinuous transmission (DTX) and/or discontinuous reception (DRX), particularly to save battery life but also to help reduce network congestion. The wireless device and the network typically negotiate time periods in which data transfer can occur by the device transmitting or receiving data respectively. During other times, the device turns its radio system off and enters a low power state. Every time the device turns its radio system on again in order to be able to transmit or receive, the device enters a high power state, reducing battery life before recharging is required.

As particular examples, a wireless device operating in a cellular network such as HSPA (high speed packet access) and LTE (Long Term Evolution) may use radio DTX/DRX with voice. Radio systems (such as HSPA) have the possibility to use discontinuous transmission and reception (DTX, DRX) at the radio level, for battery saving and network radio capacity purposes. In some systems, the DTX and DRX are dependent on each other due to underlying radio needs, such as for power control and HARQ (hybrid automatic repeat request) protocol. In practice, this means that for example stopping the DTX also stops the DRX, and vice versa. With some exceptions (e.g. GSM, IS136), the DTX and DRX also follows the U-plane activity, i.e. activity related to user-generated data, including for example (digitally encoded) voice data, email and Web data, etc. Typically, when there is U-plane activity, the radio should be fully usable with no power saving possibilities, and when the data (or voice) finishes, the device can use DTX/DRX. It is also typical that DTX/DRX is only started a given time after the last data (or voice) frame has been transmitted or received. This time to enter DTX/DRX reduces the power savings that are achieved, especially when it is long compared to the period of TX/RX events.

In a voice call over a wireless network, such as for example a cellular wireless network, there are typically periods when there is no audio data to transmit from one user's wireless device to the other via the network. Typically audio data is sent using Voice Activity Detection (VAD) which operates to optimise communication when there is no voice activity as it keeps down network traffic by avoiding the sending of unnecessary data. Modern digital lines are also relatively noise-free. These factors can both result in a listener being presented with silent periods during a voice call which can sound artificial and can lead the listener to think that the call has been lost or dropped and so result in the listener hanging up the call unnecessarily.

To counteract this, so-called comfort noise is added to fill the silent portions of transmissions with artificial noise. Thus, when there is no end user voice to transmit, the voice codec of the user device generates comfort noise frames (also known as Silence Insertion Descriptor or SID frames) to be sent over the air. These SID frames can be considered synthetic audio generated at a level comparable to the background noise at the transmitting side. The advantage of SID frames is that they contain less data than the real (background) audio and can be sent less frequently. Ideally, there is no perceived difference when changing between real background noise and synthetic background noise, such as a step change in volume level.

The generation of these SID frames typically follows a regular pattern, such as SID frames being generated and transmitted once every 160 ms. The receiver of the SID frame uses the information to generate comfort noise audio for the next 160 ms (typically, in this example). The first SID frame is transmitted practically immediately after the last actual voice frame, and therefore the timing of the pattern of SID frames (during silence) is related to the previous voice activity. This is valid for both uplink and downlink directions of voice. When the user speaks again, the sending of SID frames stops immediately and actual audio frames are transmitted instead.

In general however, the generation and transmission of audio frames (i.e. actual audio and SID frames) is currently not synchronised between the uplink (UL) and downlink (DL). This leads to the situation where DTX and DRX are frequently interrupted. More specifically, the DTX and DRX can be interrupted both for the UL and DL audio frames. Furthermore, the C-plane of the radio system requires regular radio measurements from the device back to the network. The C-plane or control-plane carries control data, i.e. the signalling protocol's traffic needed to run the system, such as paging, call set-up, etc. This activity is also typically not synchronised with U-plane (voice) activity and can interrupt the DTX/DRX activity. Moreover, where there are unaligned regular patterns of TX/RX and long timers for entering into DTX/DRX, the time where the radio can be shut off is minimal. This erodes the usefulness of the “continuous packet connectivity” or CPC feature for audio data which was one of the key targets for the feature.

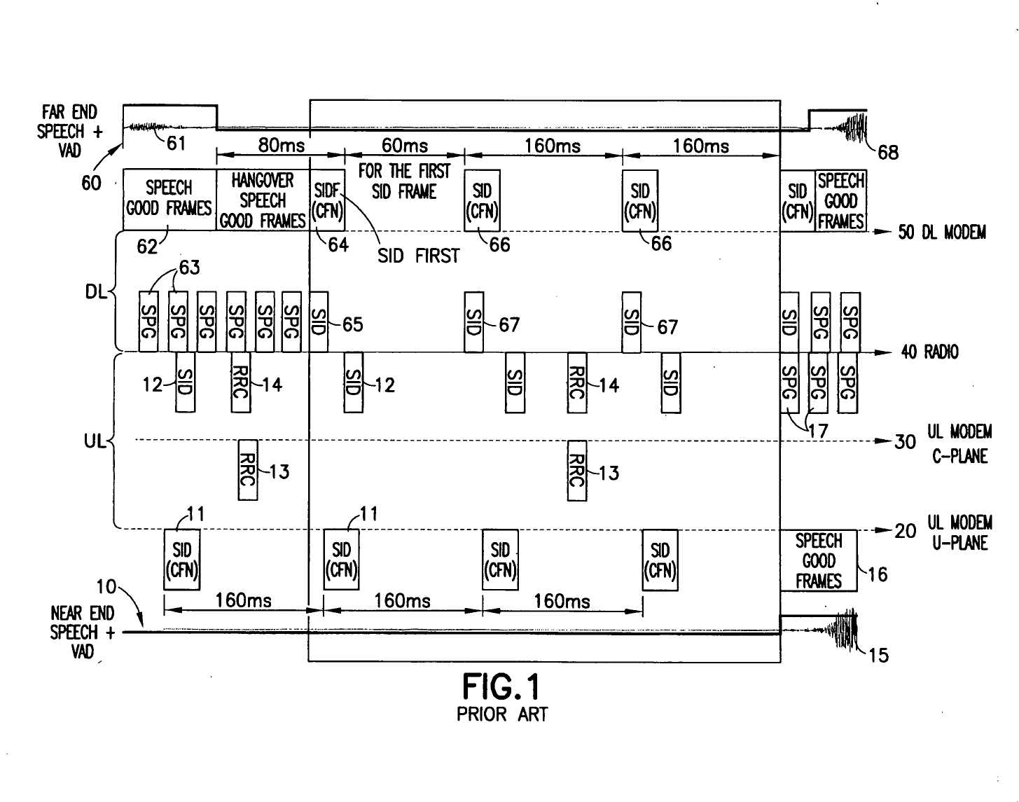

This can be seen in FIG. 1, which shows schematically a timing diagram for uplink and downlink frames in a prior art system, with time passing to the right. The lower half of the diagram shows uplink UL activity in a wireless device, with voice and voice-activated detection (VAD) local to the device being indicated at 10. The UL U-plane activity is indicated broadly at 20 and the UL C-plane activity at 30. The radio (wireless network) is indicated broadly at 40. The upper half of the diagram relates to downlink DL activity for the wireless device. The “downlink” activity of the remote wireless device (i.e. the activity that leads to downlink reception at the device being considered here) is indicated broadly at 50, with voice and voice-activated detection (VAD) at the remote wireless device being indicated at 60.

Looking first at the uplink portion, when there is no voice, the device generates SID frames 11, in this case each having a Connection Frame Number (CFN), which is a frame counter that is used for synchronisation. The generation of the SID frames 11 leads to a substantially immediate transmission of a corresponding uplink SID frame 12 over the radio network 40. The SID frames 11 are generated, and therefore the uplink SID frames 12 are transmitted, at regular intervals, which in this case is 160 ms. Separately, the device has activity on the C-plane 30. An example shown is the generation of RRC (radio resource control) reports 13 for the network, which again are transmitted substantially immediately as uplink control-plane (in this case, RRC) frames 14. After a period of time, voice activity 15 is detected, corresponding SPEECH GOOD frames 16 are generated on the U-plane 20 and corresponding uplink “actual” or SPG (“speech good”) audio frames 17 are transmitted.

On the other hand, on the downlink portion, initially voice activity 61 is detected at the remote wireless device, leading to generation of SPEECH GOOD frames 62 and transmission of corresponding downlink actual SPG audio frames 63. After a while, speech activity at the remote wireless device ceases. For a period thereafter (80 ms in the example shown), SPEECH GOOD frames 62 are still generated and corresponding uplink SPG frames 63 are transmitted. Then, to allow comfort noise to be generated at the receiving wireless device, a first SID frame 64 is generated and a corresponding downlink SID frame 65 transmitted. Subsequently, further SID frames 66 are generated and corresponding downlink SID frames 67 transmitted until voice activity is again detected 68, leading to a resumption of sending of actual SPG audio frames. The subsequent SID frames are generated 66 and thus transmitted 67 in this example 60 ms after the first SID frame 64/downlink SID frame 65, the subsequent SID frames then being generated and thus transmitted every 160 ms in this example.

Thus, as can be seen, the uplink frames, whether C-plane frames, such as RRC measurement reports, or U_plane frames such as SID frames used for comfort noise, are generated and transmitted practically immediately, without regard to the timing of each other and without regard to the timing of downlink frames being received, and indeed without regard to whether the wireless device is fully powered up to be capable of receiving data. Each activity brings the wireless device, and particularly its radio system, out of power-saving mode, which the device cannot re-enter until the DTX/DRX delay timer has expired.

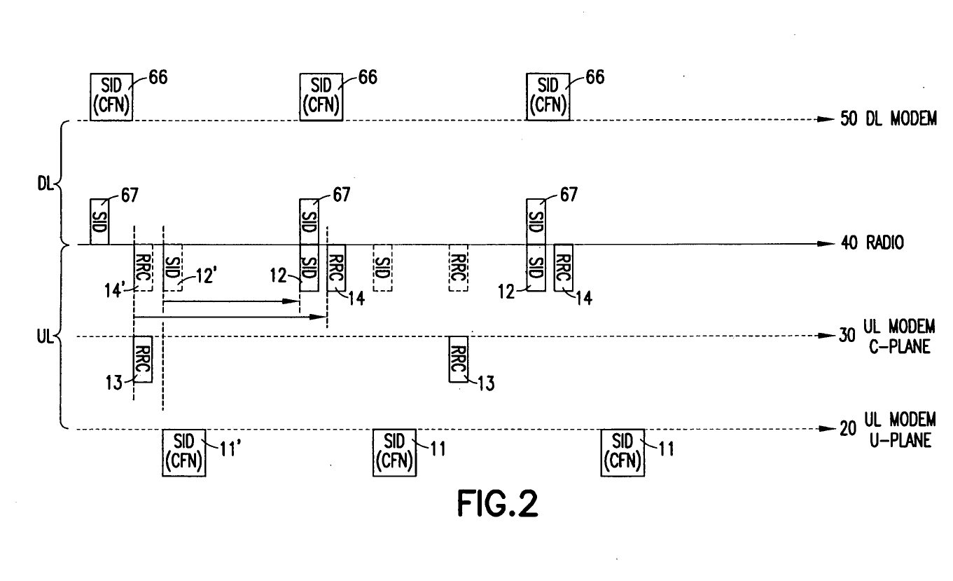

In examples of embodiments of the present invention, in broad terms, transmission of the uplink frames is scheduled to occur when it is known that the wireless device will already be powered up in order to receive downlink frames. At that time, the wireless device may actually be receiving a downlink frame (for which it will have been triggered to power up the receiver) or may be merely receptive to or “looking for” incoming downlink frames (during “awake” or powered-up periods during DRX). As will be understood and can be seen for the examples in FIGS. 2 to 4 discussed in more detail below, the transmission time for an uplink frame may coincide or be substantially simultaneous with a reception time when the wireless device is receiving or at least powered up to be able to receive a downlink frame, or the transmission time and reception time may overlap somewhat or one be entirely within the other, or the transmission time in certain examples may follow shortly after the reception time. In any event, the coordination of transmission times of uplink frames and reception times of downlink frames allows the wireless device to be idle for a maximum period of time, with minimum power-ups for transmission and reception, thus improving battery life or other power consumption of a typical wireless device.

Referring now to FIG. 2, there is shown schematically a timing diagram for transmission and reception of uplink and downlink frames in a first example of an embodiment of the present invention. Where appropriate, the same reference numerals as used for FIG. 1 are used to indicate the same or corresponding features. For reasons of clarity, only non-voice activity is shown. In this example, both the UL SID frames and the uplink RRC measurement report frames are scheduled to be transmitted when the receiver is powered up, or at least very shortly thereafter (i.e. a time that is short compared to the DRX timer that may be used such that it can be assured that the radio system of the wireless device is still powered up). In particular, in this example, after the real uplink audio frames end because of lack of voice activity at the wireless device, transmission of the first UL SID frame 11′ generated in the wireless device is delayed from when it would have taken place (shown in phantom at 12′) so that the corresponding transmitted UL SID frame 12 is transmitted when the wireless device is already powered up to receive an incoming DL frame, specifically the first DL frame to be received after the first UL SID frame 11′ is generated. In this particular example, transmission of the UL SID frame 12 is scheduled to occur when the next DL SID frame 67 is received, though it may be when the next actual DL audio frame is received, or indeed when some other DL signal is received. Transmissions of subsequent UL SID frames 12 are then scheduled to match this alignment while also meeting the regular delivery schedule. These subsequent UL SID frames 12 are simply aligned to either the DRX wakeup or the DL (actual or SID) audio frames. The purpose of aligning the first SID frame to a DL (actual or SID) audio frame in particular is to align to a likely regular event that suits the UL SID frame schedule. Similarly, transmission of the RRC measurement report frames 13 are delayed from when they would have taken place (shown in phantom at 14′) so that the corresponding transmitted UL RRC measurement frames 14 are transmitted when the wireless device is already powered up to receive an incoming DL (actual or SID) audio frame 67, in this example to follow immediately after the transmission of an UL SID frame 12 though it could also take place at the same time as transmission of an UL SID frame 12.

Changes in the nature of the DL frames, for example changing from DL actual audio frames to DL SID frames or vice versa, may disturb the alignment of the UL transmissions with the DL transmissions/DRX wake-ups. Accordingly, the wireless device may be arranged to detect such a lack of alignment, and/or detect that a change in the nature of the DL frames has occurred, and repeat the initial scheduling process to achieve alignment again.

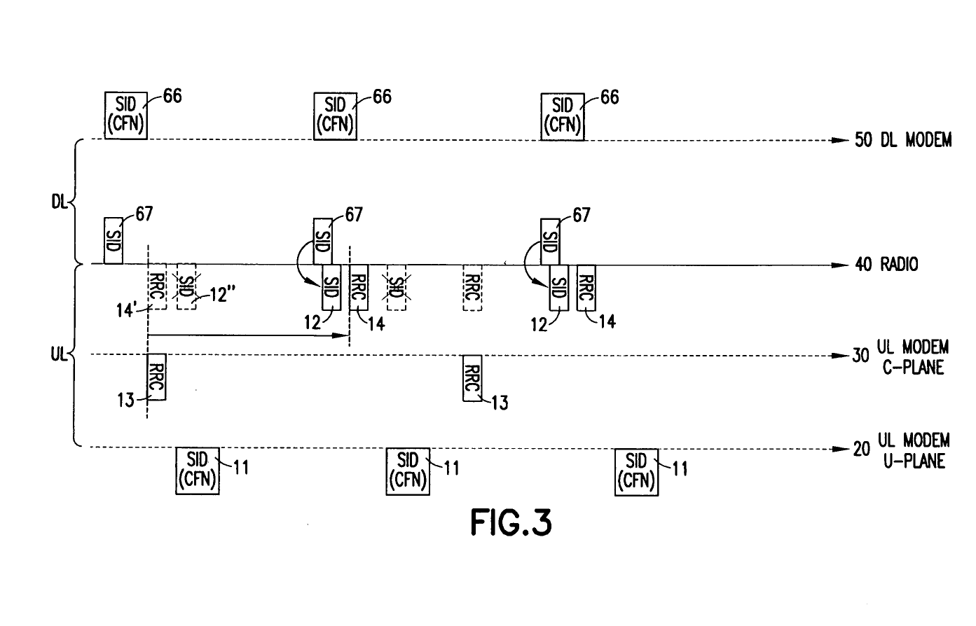

Referring now to the example shown in FIG. 3, in this case both the UL and DL audio is in silence (i.e. there is no voice activity at the current wireless device and also no voice activity at the remote wireless device). There are therefore no actual audio frames and instead only UL SID audio frames and DL SID audio frames 67. In this example, the generated UL SID frames 11 are discarded (or indeed, not generated at all), as shown schematically by at 12″. Instead, transmitted UL SID frames 12 are achieved by echoing back on the UL the DL SID frames 67 that are received at the wireless device. The alignment of the transmitted UL SID frames 12 is therefore guaranteed to align to the DL schedule as the echo back can take place practically instantaneously, or at least within a very short period of time of receipt of the corresponding DL SID frames 67. In any event, this transmission of the UL SID frames 12 takes place when the wireless device has already been powered up (to receive incoming DL SID frames 67). As for the first example, transmission of the RRC measurement report frames 13 are delayed from when they would have taken place (shown in phantom at 14′) so that the corresponding transmitted UL RRC measurement frames 14 are transmitted when the wireless device is already powered up to receive an incoming DL SID frame 67, in this example to follow immediately after the transmission of an (echoed back) UL SID frame 12.

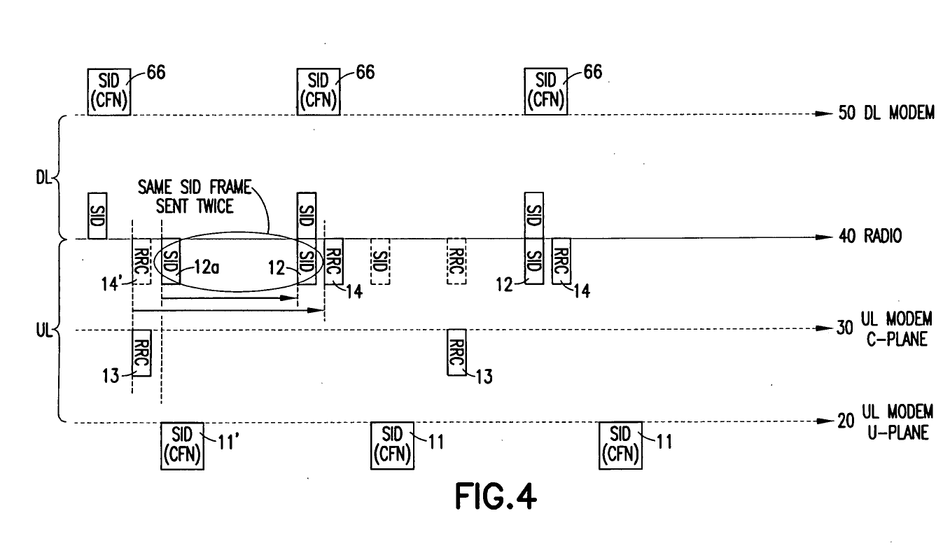

Referring now to the example shown in FIG. 4, this operates similarly to the first example shown in FIG. 2. However, in this example, after the real uplink audio frames end because of lack of voice activity at the wireless device and the first UL SID frame 11′ is generated, transmission of the first UL SID frame 11′ generated in the wireless device proceeds immediately as shown at 12a. In addition, that first generated UL SID frame 11′ is scheduled to be retransmitted as described above for the first UL SID frame 11′ of first example, in particular to be retransmitted when the receiver is powered up, or at least very shortly thereafter, so that the retransmission is aligned to either the DRX wakeup or the DL (actual or SID) audio frames. Thus, in this example, the first UL SID frame 11′ is sent twice. Subsequent SID frames 11 are transmitted as described for the first example. In addition, as in the examples above, transmission of the RRC measurement report frames 13 are delayed from when they would have taken place (shown in phantom at 14′) so that the corresponding transmitted UL RRC measurement frames 14 are transmitted when the wireless device is already powered up to receive an incoming DL SID frame 67, in this example to follow immediately after the transmission of an UL SID frame 12. This immediate transmission of the first generated UL SID frame and subsequent repetition guarantees continuity on the receiver side by avoiding any possible lengthy time gap from generation of the first UL SID frame (following detection of no voice) to transmission of the first UL SID frame.

In general, in all of the examples above, the UL SID frames are scheduled to be transmitted a maximum of every 160 ms to meet the usual requirements for comfort noise generation.

In addition, in general, in all of the examples above, each UL frame (whether an UL SID frame or an RRC measurement frame) can be marked with its delay tolerance and/or a target transmit time. The UL frames then wait to be transmitted as described above (i.e. until there is an alignment opportunity with a DRX wakeup or the wireless device is powered up to receive a DL frame). However, if that alignment opportunity does not present itself and the frame has been pending as long as it can tolerate or the target transmit time is reached, then the wireless device can trigger the end of the DTX period and make the transmission of the UL frame concerned.

Thus, in broad terms, in certain examples of embodiments of the present invention, the wireless device, or more specifically a processing system, such as a chipset or the like, of the wireless device:

(i) detects when there are SID frames in the UL and aligns them to DL audio frames or DRX wakeup periods;
(ii) generates radio measurement reports aligned to the downlink audio frames or DRX wakeup periods; and
(iii) aligns where possible the UL SID frames and the measurement reports.

This combines as much radio activity as possible into a single burst, thus achieving minimal interruption to the DTX and DRX patterns, and achieving reduced current consumption at the wireless device as it can be powered down for long periods. In general, the RRC measurement reports have a large inherent delay tolerance. However, UL SID frames in general need to be delivered to a specific regular schedule. The specific examples described here therefore focus on aligning the UL SID frames.

Embodiments of the present invention can be implemented at radio level or codec level in regard to the audio frame alignment. The codec level implementation could require some indication from the radio that the radio system could handle the frame aggregation. For example, this is possible with HSPA (high speed packet access) or LTE (Long Term Evolution) of 3GPP, but not GSM (Global System for Mobile Communications). The codec level implementation also requires extensive implementation coordination across layers. However, it has the advantage of being both suitable for VoIP (Voice over Internet Protocol) and CS (circuit switched) voice. The radio implementation is localised, but could have some consequences for VoIP. For example, the jitter buffer memory, which handles delays or other timing errors in packets, operates above the radio in VoIP, which means that the receiving jitter buffer memory could interpret the (radio-introduced aggregation) as a too severe delay to the SID frames and discard them completely. For CSoHSPA (circuit switched call over a high speed packet access network), this problem would not exist because the jitter buffer memory is at radio level, and therefore a radio implementation could also manipulate the PDCP (Packet Data Convergence Protocol) timestamp tagging (i.e. the CFNs) of the UL SID frames to work around this problem.

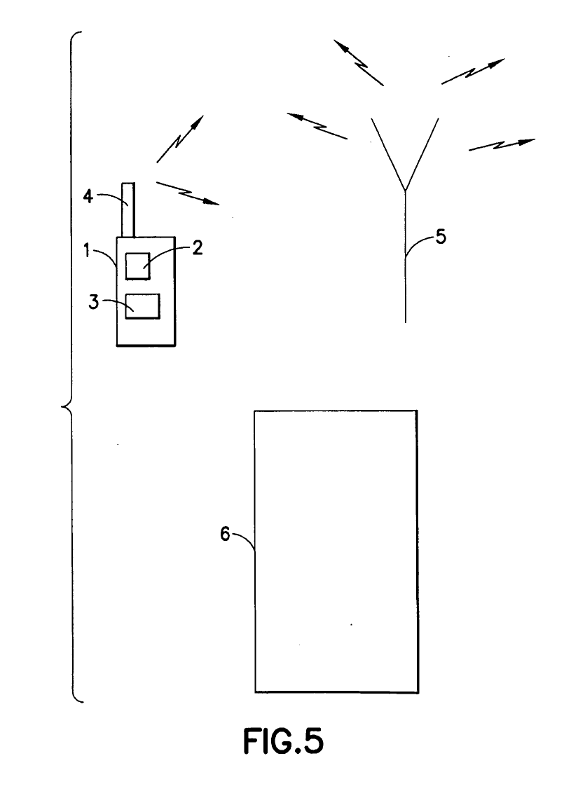

FIG. 5 shows schematically a user equipment or wireless device, in this case in the form of a mobile phone/smartphone 1. The user equipment 1 contains the necessary radio module 2, processor(s) and memory/memories 3, antenna 4, etc. to enable wireless communication with the network. The user equipment 1 in use is in communication with a radio mast 5. The radio mast 5 in this case is in the form of a Node B which is in communication with a Radio Network Controller 6.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the methods referred to herein will typically be implemented by a suitable processor or processing system or circuitry. The processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of operating a wireless device, the method comprising:
operating the wireless device such that at least a part of a radio system of the wireless device is temporarily shut down so as to be unable to receive downlink frames and is powered up so as to be capable of receiving downlink frames; and
the wireless device scheduling the transmission time of an uplink frame to occur when the radio system of the wireless device has been powered up so that the wireless device is capable of receiving a downlink frame.

2. A method according to claim 1, wherein the wireless device operates using discontinuous reception in which a receiver of the wireless device is periodically switched on and off and the wireless device operates using discontinuous transmission in which a transmitter of the wireless device is periodically switched on and off, the scheduling of the transmission time of the uplink frame being such as to cause the transmitter to be switched on when the receiver has been switched on.

3. A method according to claim 1, wherein the wireless device schedules the transmission time of an uplink frame to substantially align with the time when the wireless device is receiving a downlink frame.

4. A method according to claim 1, wherein the wireless device schedules the transmission time of an uplink frame to occur after the wireless device begins receiving a downlink frame.

5. A method according to claim 1, wherein the uplink frame is a control-plane frame or a silence insertion descriptor frame.

6. A method according to claim 4, wherein the wireless device receives a downlink frame that is a silence insertion descriptor frame and the uplink frame is a silence insertion descriptor frame that is an echo back of the received downlink silence insertion descriptor frame.

7. A method according to claim 1, wherein the wireless device is transmitting actual audio frames and then ceases sending actual audio frames and generates a first silence insertion descriptor frame, the scheduling of the transmission of the first silence insertion descriptor frame being such that transmission of the first silence insertion descriptor frame is delayed as necessary so as to occur when the radio system of the wireless device is next powered up to be capable of receiving a downlink frame.

8. A method according to claim 1, wherein the wireless device is transmitting actual audio frames and then ceases sending actual audio frames and sends a first silence insertion descriptor frame, the first silence insertion descriptor frame being retransmitted when the radio system of the wireless device is next powered up to be capable of receiving a downlink frame.

9. A method according to claim 1, wherein the downlink frame is an actual audio frame or a silence insertion descriptor frame.

10. A method according to claim 1, wherein the wireless device reschedules the transmission time of the uplink frame if a target transmission time of the uplink frame occurs before the wireless device has been powered up so that the wireless device is capable of receiving a downlink frame, or if a delay tolerance for the uplink frame is exceeded.

11. Apparatus comprising:
at least one processor;
and at least one memory including computer program code;
the at least one memory and the computer program code being configured to, with the at least one processor, cause a wireless device that includes the apparatus at least:
to operate such that at least a part of a radio system of the wireless device is temporarily shut down so as to be unable to receive downlink frames and is powered up so as to be capable of receiving downlink frames; and
to schedule the transmission time of an uplink frame to occur when the radio system of the wireless device has been powered up so that the wireless device is capable of receiving a downlink frame.

12. Apparatus according to claim 11, constructed and arranged to cause the wireless device to operate using discontinuous reception in which a receiver of the wireless device is periodically switched on and off and to operate using discontinuous transmission in which a transmitter of the wireless device is periodically switched on and off, the scheduling of the transmission time of the uplink frame being such as to cause the transmitter to be switched on when the receiver has been switched on.

13. Apparatus according to claim 11, constructed and arranged to cause the wireless device to schedule the transmission time of an uplink frame to substantially align with the time when the wireless device is receiving a downlink frame.

14. Apparatus according to claim 11, constructed and arranged to cause the wireless device to schedule the transmission time of an uplink frame to occur after the wireless device begins receiving a downlink frame.

15. Apparatus according to claim 14, constructed and arranged such that the uplink frame is a silence insertion descriptor frame that is an echo back of a received downlink silence insertion descriptor frame.

16. Apparatus according to claim 11, constructed and arranged such that the wireless device transmits actual audio frames and then ceases sending actual audio frames and generates a first silence insertion descriptor frame, the scheduling of the transmission of the first silence insertion descriptor frame being such that transmission of the first silence insertion descriptor frame is delayed as necessary so as to occur when the radio system of the wireless device is next powered up to be capable of receiving a downlink frame.

17. Apparatus according to claim 11, constructed and arranged such that the wireless device transmits actual audio frames and then ceases sending actual audio frames and sends a first silence insertion descriptor frame, the first silence insertion descriptor frame being retransmitted when the radio system of the wireless device is next powered up to be capable of receiving a downlink frame.

18. Apparatus according to claim 11, constructed and arranged such that the wireless device reschedules the transmission time of the uplink frame if a target transmission time of the uplink frame occurs before the wireless device has been powered up to be capable of receiving a downlink frame, or if a delay tolerance for the uplink frame is exceeded.

19. A wireless device comprising apparatus according to claim 11.

20. A computer program comprising code such that when the computer program is executed on a computing device, the computing device is arranged to carry out a method according to claim 1.
